(19) United States
(12) Patent Application Publication
(10) Pub. No.: US 2025/0308266 A1
(43) Pub. Date: Oct. 2, 2025

(54) MACHINE LEARNING HISTOLOGICAL ANALYSIS FOR IDENTIFICATION OF MOLECULAR FEATURES

(71) Applicant: Genentech, Inc., South San Francisco, CA (US)

(72) Inventors: Aminollah KHORMALI, South San Francisco, CA (US); Kai LIU, Belmont, CA (US); Yasin SENBABAOGLU, South San Francisco, CA (US)

(21) Appl. No.: 19/236,866

(22) Filed: Jun. 12, 2025

Related U.S. Application Data
(63) Continuation of application No. PCT/US2023/083905, filed on Dec. 13, 2023.
(60) Provisional application No. 63/387,462, filed on Dec. 14, 2022.

(51) Int. Cl. G06V 20/69; G06V 10/42; G06V 10/44; G06V 20/70

(52) U.S. Cl. CPC G06V 20/695; G06V 10/42; G06V 10/44; G06V 20/698; G06V 20/70; G06V 2201/03

(57) ABSTRACT

A method may include determining, within an image of a biological sample, a first plurality of tiles having a first tile size and a second plurality of tiles having a second tile size. A feature extraction model may be applied to extract features from the different size tiles. Concatenated feature sets, each of which including a first feature of a first tile from the first plurality of tiles, a second feature of a second tile from the second plurality of tiles, and a third feature of a third tile from the second plurality of tiles, may be formed. Molecular features present in the biological sample may be determined based on an attention-weighted position embedding of the concatenated feature sets and a joint representation of features across clusters of spatially proximate tiles in the image. Related systems and computer program products are also provided.

### CROSS-REFERENCE TO RELATED APPLICATIONS

This application is a continuation of International Patent Application No. PCT/US2023/083905, filed on Dec. 13, 2023, which claims priority to U.S. Provisional Patent Application No. 63/387,462, filed Dec. 14, 2022, entitled “MACHINE LEARNING HISTOLOGICAL ANALYSIS FOR IDENTIFICATION OF MOLECULAR FEATURES,” the contents of each of which is hereby incorporated by reference in its entirety.

### TECHNICAL FIELD

The subject matter described herein relates generally to the digital and computational pathology and more specifically to a deep learning approach to identifying molecular features in histological images.

### INTRODUCTION

A cell's phenotype may refer to a unique combination of morphological and functional characteristics that result from various cellular processes including, for example, gene expression, protein expression, and/or the like. In some cases, complex interactions between a cell's genome, epigenome, and local environment may give rise to an assortment of observable characteristics collectively known as the cell's phenotype. While cellular phenotypes, including the phenotypes of tumor cells, are typically attributed to genomic instability, increasing attention has recently been given to epigenetic and microenvironmental influences. Such non-genetic factors can further increase the intrinsic diversity and plasticity of tumor cells. At the tumor level, non-genetic factors can contribute to greater phenotypic heterogeneity that allows tumor cells to evade immune responses and resist drug intervention.

### SUMMARY

Systems, methods, and articles of manufacture, including computer program products, are provided for machine learning enabled identification of molecular features in histological images. In one aspect, there is provided a system that includes at least one processor and at least one memory. The at least one memory may include program code that provides operations when executed by the at least one processor. The operations may include: determining, within an image of a biological sample, a first plurality of tiles having a first tile size; determining, within the image of the biological sample, a second plurality of tiles having a second tile size; applying a feature extraction model to extract a first plurality of features from the first plurality of tiles of the first size; applying the feature extraction model to extract a second plurality of features from the second plurality of tiles of the second size; and determining, based at least on the first plurality of features and the second plurality of features, one or more molecular features present in the biological sample depicted in the image.

In another aspect, there is provided a method for machine learning enabled identification of molecular features in histological images. The method may include: determining, within an image of a biological sample, a first plurality of tiles having a first tile size; determining, within the image of the biological sample, a second plurality of tiles having a second tile size; applying a feature extraction model to extract a first plurality of features from the first plurality of tiles of the first size; applying the feature extraction model to extract a second plurality of features from the second plurality of tiles of the second size; and determining, based at least on the first plurality of features and the second plurality of features, one or more molecular features present in the biological sample depicted in the image.

In another aspect, there is provided a computer program product for machine learning enabled identification of molecular features in histological images. The computer program product may include a non-transitory computer readable medium storing instructions that cause operations when executed by at least one data processor. The operations may include: determining, within an image of a biological sample, a first plurality of tiles having a first tile size; determining, within the image of the biological sample, a second plurality of tiles having a second tile size; applying a feature extraction model to extract a first plurality of features from the first plurality of tiles of the first size; applying the feature extraction model to extract a second plurality of features from the second plurality of tiles of the second size; and determining, based at least on the first plurality of features and the second plurality of features, one or more molecular features present in the biological sample depicted in the image.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to the machine learning enabled identification of gene expressions, protein expressions, and gene signature expressions in histological images, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a system diagram illustrating an example of a digital pathology system, in accordance with some example embodiments;

FIG. 2A depicts a flowchart illustrating an example of a process for machine learning enabled identification of molecular features in histological images, in accordance with some example embodiments;

FIG. 2B depicts a flowchart illustrating another example of a process for machine learning enabled identification of molecular features in histological images, in accordance with some example embodiments;

FIG. 3 depicts a schematic diagram illustrating an example of a histological computation model, in accordance with some example embodiments;

FIG. 4A depicts a schematic diagram illustrating an example of a tile extractor and a feature extractor, in accordance with some example embodiments;

FIG. 4B depicts a schematic diagram illustrating an example of cross-cluster attention, in accordance with some example embodiments;

FIG. 5 depicts an example of preprocessing a histological image, in accordance with some example embodiments;

FIG. 6 depicts a graph illustrating a structural similarity (SSIM) index as a measure of concordance between transforming growth factor (TGF)-β inhibited membrane associated protein (TIMAP) cell type predictions and tile-level gene expression predictions made by a histological computation model, in accordance with some example embodiments;

FIG. 7A depicts histological images illustrating the concordance between tumor cells identified through transforming growth factor (TGF)-β inhibited membrane associated protein (TIMAP) cell type prediction and tile-level gene expression predictions made by a histological computation model, in accordance with some example embodiments;

FIG. 7B depicts histological images illustrating the concordance between lymphocytes identified through transforming growth factor (TGF)-β inhibited membrane associated protein (TIMAP) cell type prediction and tile-level gene expression predictions made by a histological computation model, in accordance with some example embodiments;

FIG. 7C depicts histological images illustrating the concordance between fibroblasts identified through transforming growth factor (TGF)-β inhibited membrane associated protein (TIMAP) cell type prediction and tile-level gene expression predictions made by a histological computation model, in accordance with some example embodiments;

FIG. 8A depicts histological images of tumor regions localized based on molecular features identified by a histological computation model, in accordance with some example embodiments;

FIG. 8B depicts histological images of intratumor heterogeneity captured based on molecular features identified by a histological computation model, in accordance with some example embodiments; and

FIG. 8C depicts the concordance between cyclin spatial patterns identified by a histological computation model and cyclin bulk RNA-sequence expression patterns, in accordance with some example embodiments;

FIG. 9A depicts various examples of signatures associated with tiles depicting lymphocytes in a histological image, in accordance with some example embodiments;

FIG. 9B depicts various examples of signatures associated with tiles depicting adipose, tumor, and mucus tissue structures in a histological image, in accordance with some example embodiments;

FIG. 10A depicts histological images illustrating fatty acid oxidation and proton transport signature colocalization being a predictive biomarker for prediction of clinical outcomes, in accordance with some example embodiments;

FIG. 10B depicts histological images illustrating amino acid catabolism and neuron signature colocalization being a predictive biomarker for prediction of clinical outcomes, in accordance with some example embodiments; and

FIG. 11 depicts a block diagram illustrating an example of a computing system, in accordance with some example embodiments.

When practical, similar reference numbers denote similar structures, features, or elements.

### DETAILED DESCRIPTION

In highly heterogeneous diseases such as cancer, insights into the molecular features present in diseased tissue and the surrounding microenvironment may be integral to the accurate clinical endpoint predictions. For example, certain molecular features, such as gene expressions, protein expressions, and gene signature expressions, may serve as biomarkers for the diagnosis of disease subtype, prognosis of disease progress, and prediction of response to various treatments. Nevertheless, conventional histological analysis techniques for identifying molecular features in a microscopic image (e.g., a hematoxylin and eosin (H&E) stained whole slide image, a multiplex immunofluorescence (MxIF) stained whole slide image, and/or the like), including deep learning based approaches, are focused on fixed sized features whereas key insights are often found across a range of different sized features, for example, from millimeter-scale features such as vessels to cellular-scale features such as the tissue microenvironment.

In some example embodiments, a histological computation model may apply a hybrid multiple-instance learning (MIL) approach to different sized tiles in an image (e.g., a whole slide image (WSI) and/or the like) of a biological sample. For example, the histological computation model may extract, from the image of the biological sample, a first plurality of tiles of a first size (e.g., 224×224 pixels) that captures features at a first scale (e.g., cellular scale) and a second plurality of tiles of a second size (e.g., 56×56 pixels) that captures features at a second scale (e.g., millimeter scale). Furthermore, the histological computation model may concatenate a first plurality of features extracted from the first plurality of tiles of the first size with a second plurality of features extracted from the second plurality of tiles of the second size. For instance, in some cases, the histological computation model may apply a pyramidal concatenation where features from a larger tile covering a portion of the image are concatenated with features from two or more smaller tiles covering the same (or similar) portion of the image. Accordingly, a first feature associated with a first tile of the first size are concatenated with at least a second feature associated with a second tile of the second size and a third feature associated with a third tile of the second size. Furthermore, in some cases, the first feature associated with the first tile of the first size may be concatenated with a second feature from the first tile of the first size, a third feature from the second tile of the second size, and a fourth feature from the third tile of the second size.

In some example embodiments, the histological computation model may determine, based on a joint representation of key instances from the first plurality of tiles of the first size and the second plurality of tiles of the second size, one or more bag-level for the image of the biological sample. For example, the bag-level label for the image may indicate whether the biological sample depicted in the image is associated with a molecular feature such as a gene expression, a protein expression, or a gene signature expression. In this context, the biological sample may be associated with the molecular feature if the biological sample is positive for (or exhibits) the molecular feature and the biological sample may not be associated with the molecular feature if the biological sample is negative for (or does not exhibit) the molecular feature.

In some example embodiments, the bag-level label may be determined based at least on a joint representation of key instances included in the first plurality of tiles and the second plurality of tiles. In some cases, the bag-level label for the image may be determined based on a positional embedding of the first plurality of features extracted from the first plurality of tiles of the first size concatenated with the second plurality of features extracted from the second plurality of tiles of the second size. For example, the positional embedding may include a first position of the first tile of the first size embedded with the first feature extracted from the first tile, a second position of the second tile of the second size embedded with the second feature extracted from the second tile, and a third position of the third tile of the second size embedded with the third feature extracted from the third tile. Accordingly, the bag-level label for the image may be determined to take into account different scale features from different sized tiles as well as the spatial distribution of these features within the image.

In some example embodiments, the histological computation model may include an attention mechanism to identify one or more key instances across the individual tiles when determining the bag-level label for the image. Accordingly, in some cases, the histological computation model may include an attention generator network trained to determine, for each positional embedding (e.g., of the first feature of the first tile of the first size concatenated with the second feature of the second tile of the second size and the third feature of the third tile of the second size), a corresponding attention weight indicative of whether the corresponding instance triggers the bag-level label for the image. For example, in some cases, the bag-level label for the image of the biological sample may be a binary value indicative of whether the biological sample is associated with a particular molecular feature. The key instances in this case may refer to tiles (or clusters of tiles) that trigger the bag-level label for the image by at least causing the bag-level label to take on either a first value indicative of the biological sample being associated with (or positive for) the molecular feature or a second value indicative of the biological sample not being associated with (or negative for) the molecular feature.

In some example embodiments, the histological computation model may determine multiple bag-level labels for the image of the biological sample each of which indicating, for example, whether the biological sample depicted in the image is associated with a molecular feature such as gene expression, gene signature expression, protein expression, and/or the like. For example, the histological computation model may determine a first bag-level label for the image based on the attention-weighted instances of position embedded and concatenated feature sets from the first plurality of tiles and/or the second plurality of tiles. In this context, each instance included in the image of the biological sample may refer to the positional embedding of a concatenated feature set including, for example, a first feature associated with a first tile of the first size are concatenated with at least a second feature associated with a second tile of the second size and a third feature associated with a third tile of the second size. Moreover, in some cases, the histological computation model may perform attention based tile selection and pooling followed by instance regression to determine, based at least on the attention-weighted instances, the first bag-level label for the image of the biological sample.

In some example embodiments, the histological computation model may also determine a second bag-level label for the image based on different tile clusters within the image of the biological sample. For example, in some cases, the histological computation model may perform a position-based clustering to identify, within the first plurality of tiles and the second plurality of tiles in the image, one or more clusters of spatially proximate tiles. The histological computation model may perform a cross-cluster attention map distillation in order to determine, for each tile cluster, a label identifying the molecular feature present in the tiles that are found in the other tile clusters. Moreover, the histological computation model may determine, for each tile cluster, a set of cross-cluster attention weights that includes a first average attention weight of the tiles that are within the tile cluster and a second average attention weight of the tiles that are in the other tile clusters. In some cases, the histological computation model may determine, based at least on the set of cross-cluster attention weights associated with each tile cluster, the second bag-level label for the image of the biological sample. For instance, in some cases, the histological computation model may perform attention based cluster selection and pooling followed by bag-level regression to determine, based at least on the attention-weighted tile clusters, the second bag-level label for the image as a whole. In some cases, the histological computation model may determine, based at least on the first bag-level label determined through instance-level regression and the second bag-level label determined through bag-level regression, an overall label for the image indicating, for example, whether the biological sample depicted in the image is associated with a molecular feature such as gene expression, gene signature expression, protein expression, and/or the like.

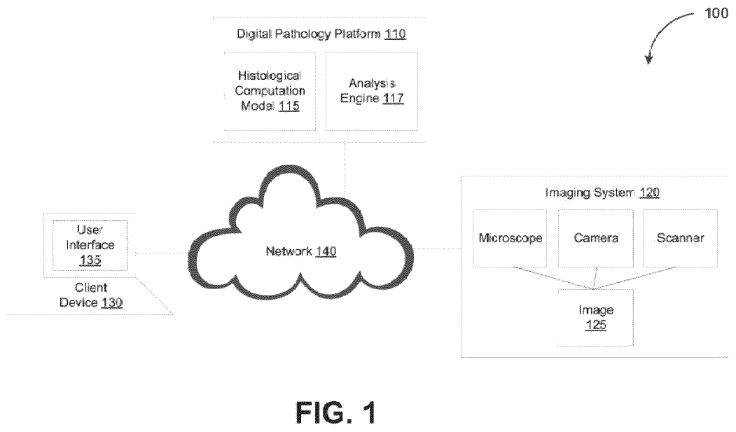

FIG. 1 depicts a system diagram illustrating an example of a digital pathology system 100, in accordance with some example embodiments. Referring to FIG. 1, the digital pathology system 100 may include a digital pathology platform 110, an imaging system 120, and a client device 130. As shown in FIG. 1, the digital pathology platform 110, the imaging system 120, and the client device 130 may be communicatively coupled via a network 140. The network 140 may be a wired network and/or a wireless network including, for example, a local area network (LAN), a virtual local area network (VLAN), a wide area network (WAN), a public land mobile network (PLMN), the Internet, and/or the like. The imaging system 120 may include one or more imaging devices including, for example, a microscope, a digital camera, a whole slide scanner, a robotic microscope, and/or the like. The client device 130 may be a processor-based device including, for example, a workstation, a desktop computer, a laptop computer, a smartphone, a tablet computer, a wearable apparatus, and/or the like.

Referring again to FIG. 1, the digital pathology platform 110 may include a histological computation model 115 and an analysis engine 117. In the example shown in FIG. 1, the digital pathology platform 110 may apply, to an image 125 of a biological sample, the histological computation model 115 to identify one or more molecular features present in the biological sample. Examples of molecular features may include gene expressions, gene signature expressions, and protein expressions as well as genetic mutations, copy number alterations (CNAs), cellular phenotypes, and/or the like. In some cases, the first image 125 may be a stained whole slide image (WSI) including, for example, a hematoxylin and eosin (H&E) stained whole slide image, a multiplex immunofluorescence (MxIF) stained whole slide image, an immunohistochemical (IHC) stained whole slide image, and/or the like. In some cases, the analysis engine 117 may determine, based at least on the one or more molecular features present in the biological sample, at least one of a disease diagnosis, a disease progress, a disease burden, a treatment, a treatment response, and survival prediction for a patient associated with the biological sample. Alternatively and/or additionally, the analysis engine 117 may identify, based at least on the one or more molecular features present in the biological sample, one or more biomarkers and disease-modifying target genes. In some cases, the analysis engine 117 may also perform, based at least on the one or more molecular features present in the biological sample, bulk RNA sequence prediction and in silico spatial transcriptomics to determine the spatial distribution of genetic activities occurring within the biological sample.

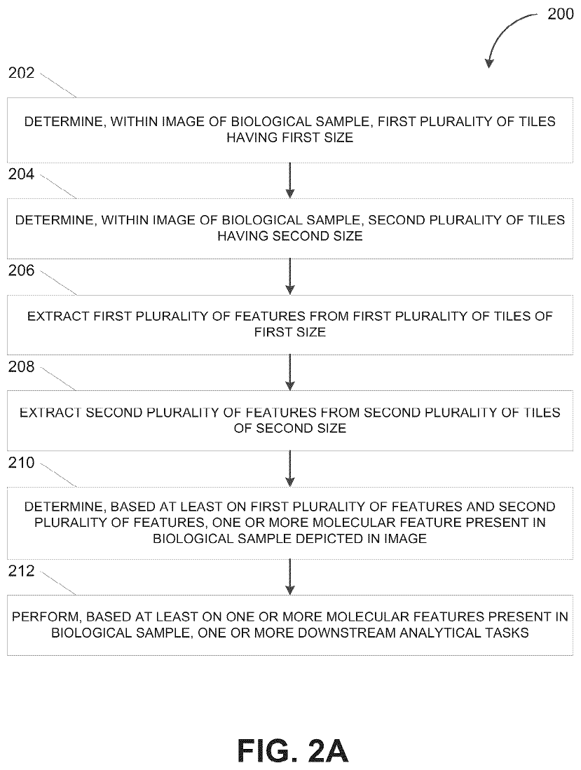

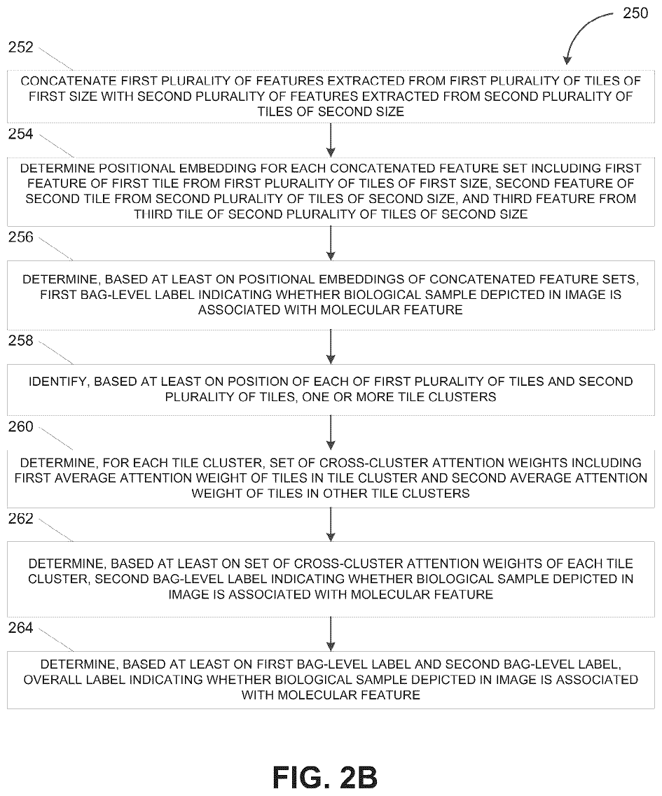

FIG. 2A depicts a flowchart illustrating an example of a process 200 for machine learning enabled identification of molecular features in histological images, in accordance with some example embodiments. Referring to FIG. 2A, the process 200 may be performed by the digital pathology platform 110 to determine, for example, a bag-level label indicating whether the biological sample depicted in the image 125 is associated with a molecular features including, for example, gene expressions, gene signature expressions, and protein expressions, genetic mutations, copy number alterations (CNAs), cellular phenotypes, and/or the like.

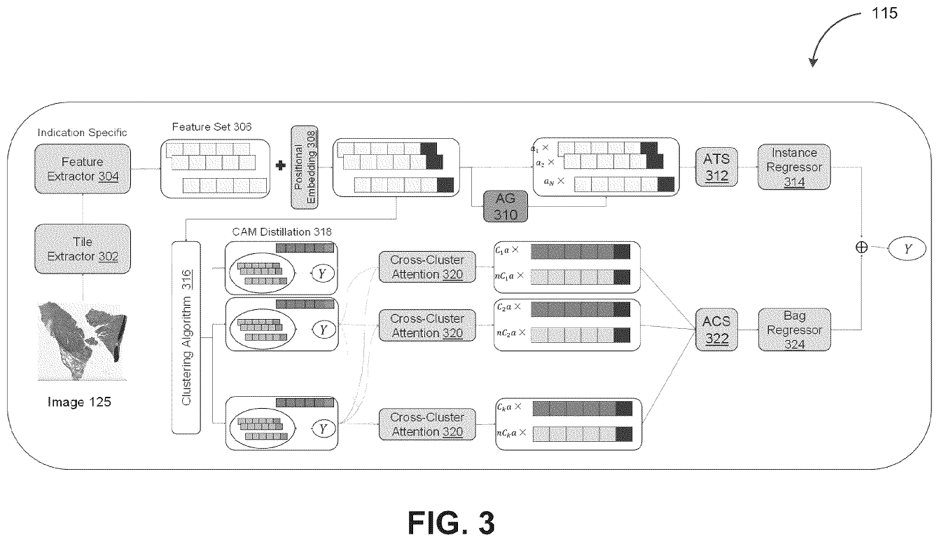

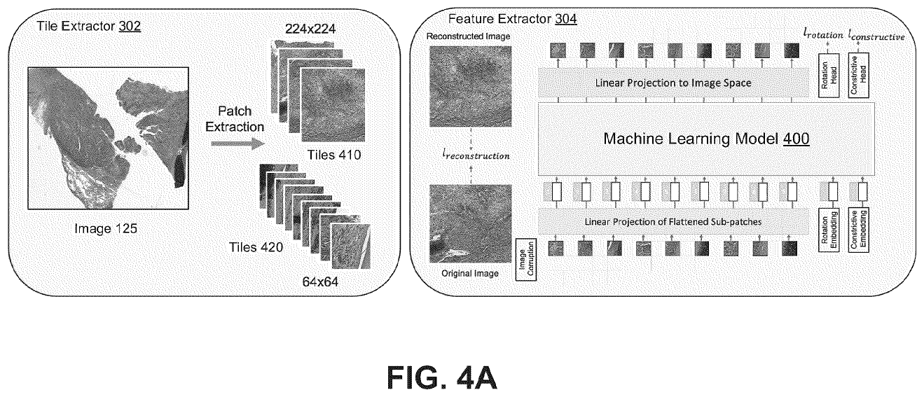

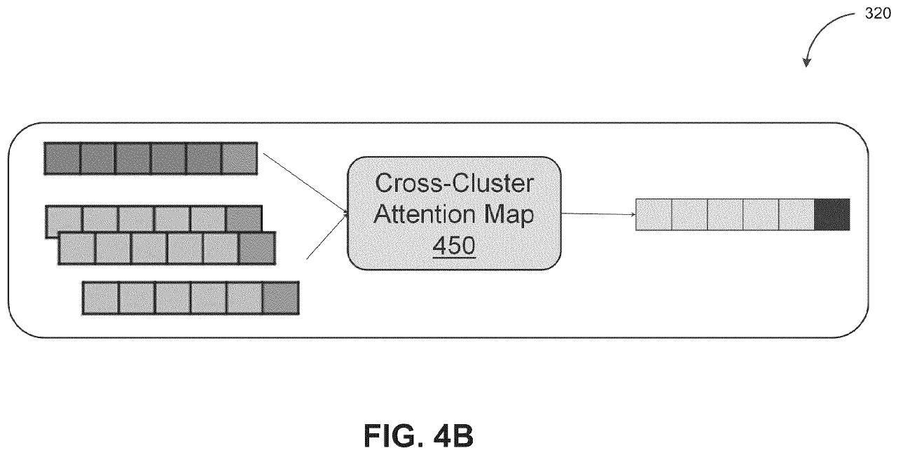

At 202, the digital pathology platform 110 may determine, within an image of a biological sample, a first plurality of tiles having a first size. In some example embodiments, the digital pathology platform 110 may extract, from the image 125 of the biological sample, different size tiles in order to capture features at different scales such as, for example, millimeter-scale features such as vessels and cellular-scale features such as the tissue microenvironment. To further illustrate, FIG. 3 depicts a schematic diagram illustrating an example of the histological computation model 115, in accordance with some example embodiments. As shown in FIG. 3, the histological computation model 115 may include a tile extractor 302. FIG. 4A depicts a schematic diagram illustrating an example of the tile extractor 302, in accordance with some example embodiments. As shown in FIG. 4A, the tile extractor 302 may perform patch extraction to extract, from the image 125 of the biological sample, a first plurality of tiles 410 of a first size (e.g., 224×224 pixels). In some cases, the first plurality of tiles 410 of the first size may capture features at a first scale such as, for example, global features or cellular-scale features present in the image 125.

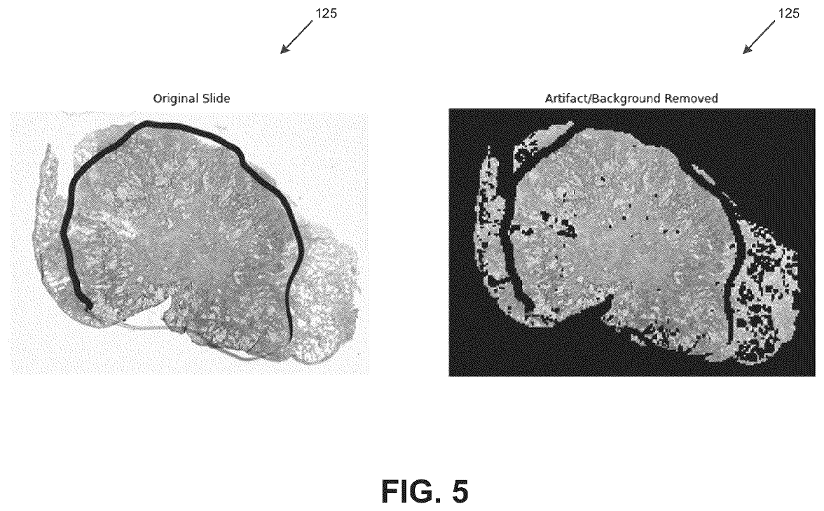

In some cases, prior to the application of the histological computation model 115, the image 125 may undergo various forms of image preprocessing. For example, in some cases, the image 125 may be preprocessed to reduce and/or remove artifacts. Alternatively and/or additionally, in some cases, the image 125 may be preprocessed to remove one or more background portions of the image 125. FIG. 5 depicts one example in which the image 125 is preprocessed to remove artifacts and background. Furthermore, in some cases, when determining the first plurality of tiles 410, the tile extractor 302 may exclude one or more tiles in which less than a threshold portion of the tile (e.g., less than 50% or another threshold portion of the tile) is covered by the biological sample.

At 204, the digital pathology platform 110 may determine, within the image of the biological sample, a second plurality of tiles having a second size. Referring again to FIGS. 3 and 4A, in some example embodiments, the tile extractor 302 (or a different tile extractor) of the histological computation model 115 may extract, from the image 125 of the biological sample, a second plurality of tiles 420 of a second size. In some cases, the second plurality of tiles 420 of the second size may include a different quantity of pixels (e.g., 64×64 pixels) as the first plurality of tiles 420. Moreover, in some cases, a single tile of the first plurality of tiles 410 may cover a same (or similar) portion of the image 125 as two or more tiles of the second plurality of tiles 420. Accordingly, in some cases, the second plurality of tiles 420 of the second size may capture features at a second scale such as, for example, local features or millimeter-scale features present in the image 125. Moreover, although FIG. 4A shows each tile of the first plurality of tiles 410 and the second plurality of tiles 420 being equally sized tiles, the first plurality of tiles 410 and/or the second plurality of tiles 420 may also include different sized tiles. For example, in some cases, the two or more tiles of the second plurality of tiles 420 covering the same (or similar) portion of the image 125 as the single tile of the first plurality of tiles 410 may have the same size or different sizes. Furthermore, a same quantity or different quantities of tiles from the second plurality of tiles 420 of the second size may be associated with each tile of the first plurality of tiles 410 of the first size. For instance, while a first quantity tiles from the second plurality of tiles 420 of the second size may be associated with a first tile of the first plurality of tiles 410 of the first size, the same first quantity of tiles or a different second quantity of tiles from the second plurality of tiles 420 may be associated with a second tile of the first plurality of tiles 410. In some cases, when determining the second plurality of tiles 420 of the second size, the tile extractor 302 may exclude one or more tiles in which less than a threshold portion of the tile (e.g., less than 50% or another threshold portion of the tile) is covered by the biological sample.

At 206, the digital pathology platform 110 may extract a first plurality of features from the first plurality of tiles of the first size. Referring again to FIGS. 3 and 4A, the histological computation model 115 may include a feature extractor 304 (e.g., including a machine learning model 400 such as a vision transformer and/or the like) trained to extract, from the first plurality of tiles 410 of the first size, a first plurality of features. In some cases, the first plurality of features may be at a first scale (e.g., global scale or cellular-scale) corresponding to the first size of the first plurality of tiles 410. In the example shown in FIG. 3, the feature extractor 304 is an indication specific feature extractor that is trained to recognize and extract features that are associated with a specific disease or a specific subclass of disease such as cancer. However, it should be appreciated that the feature extractor 304 may also be implemented as a generic feature extractor trained to recognize and extract features associated with multiple diseases or multiple subclasses of diseases.

At 208, the digital pathology platform 110 may extract a second plurality of features from the second plurality of tiles of the second size. In some cases, the feature extractor 304 (or a different feature extractor) of the histological computation model 115 may also be trained to extract, from the second plurality of tiles 420 of the second size, a second plurality of features. In some cases, the second plurality of features may be at a second scale (e.g., local scale or millimeter-scale) corresponding to the second size of the second plurality of tiles 420.

At 210, the digital pathology platform 110 the determining, based at least on the first plurality of features and the second plurality of features, one or more molecular features present in the biological sample depicted in the image. In some example embodiments, the histological computation model 115 may determine, based at least on the first plurality of features extracted from the first plurality of tiles 410 of the first size and the second plurality of features extracted from the second plurality of tiles 420 of the second size, one or more bag-level labels for the image 125. In some cases, the bag-level labels for the image 125 may be determined based at least on a positional embedding 308 of a concatenated feature set 306. For example, in some cases, the concatenated feature set 306 may include a first feature associated with a first tile from the first plurality of tiles 410 of the first size concatenated with at least a second feature associated with a second tile from the second plurality of tiles 420 of the second size and a third feature associated with a third tile from the second plurality of tiles 420 of the second size. Furthermore, in some cases, the concatenated feature set 306 may include the first feature associated with the first tile of the first size, a second feature from the first tile of the first size, a third feature from the second tile of the second size, and a fourth feature from the third tile of the second size. Meanwhile, the positional embedding 308 of the concatenated feature set 306 may further include a first position of the first tile, a second position of the second tile, and/or a third position of the third tile. In some cases, the first position of the first tile, the second position of the second tile, and the third position of the third tile may each include a set of coordinates of one or more pixels included in the corresponding tile such as, for example, the one or more pixels occupying a corner (e.g., top left corner) of the corresponding tile. As will be described in more detail below, in some cases, the bag-level labels indicating whether the biological sample depicted in the image 125 is associated with a molecular feature may be determined based at least on attention-weighted instances, each of which corresponding to the positional embedding of concatenated features from across the first plurality of tiles 410 and the second plurality of tiles 420.

At 212, the digital pathology platform 110 may perform, based at least on the one or more molecular features present in the biological sample, one or more downstream analytical tasks. In some example embodiments, the digital pathology platform 110, for example, the analysis engine 117, may perform a variety of downstream analytical tasks based on the one or more molecular features, such as gene expressions, gene signature expressions, and protein expressions as well as genetic mutations, copy number alterations (CNAs), cellular phenotypes, and/or the like, identified as present (or absent) in the biological sample depicted in the image 125. For example, in some cases, the analytical engine 117 may determine, based at least on the one or more molecular features identified as present (or absent) from the biological sample, at least one of a disease diagnosis, a disease progress, a treatment, a treatment response, and survival prediction for a patient associated with the biological sample. In some cases, the analysis engine 117 may also identify, based at least on the one or more molecular features identified as present (or absent) from the biological sample, one or more biomarkers and disease-modifying target genes. Alternatively and/or additionally, in some cases, the analysis engine 117 may perform, based at least on the one or more molecular features identified as present (or absent) in the biological sample, bulk RNA sequence prediction and in silico spatial transcriptomics to determine the spatial distribution of genetic activities occurring within the biological sample.

FIG. 2B depicts a flowchart illustrating an example of a process 250 for machine learning enabled identification of molecular features in histological images, in accordance with some example embodiments. Referring to FIG. 2B, the process 250 may be performed by the digital pathology platform 110 to determine, based on features extracted from different sized tiles in the image 125, a bag-level label indicating whether the biological sample depicted in the image 125 is associated with a molecular features including, for example, gene expressions, gene signature expressions, and protein expressions, genetic mutations, copy number alterations (CNAs), cellular phenotypes, and/or the like. In some cases, the process 250 may implement operation 210 of the process 200 described with respect to FIG. 2A.

At 252, the digital pathology platform 110 may concatenate a first plurality of features extracted from a first plurality of tiles of a first size with a second plurality of features extracted from a second plurality of tiles of a second size. For example, as shown in FIGS. 3 and 4A, the digital pathology platform 110 may generate, based at least on the first plurality of features extracted from the first plurality of tiles 410 of the first size and the second plurality of features extracted from the second plurality of tile 420 of the second size, the concatenated feature set 306. In some cases, the concatenated feature set 306 may include, for example, a concatenation of a first feature of a first tile from the first plurality of tiles 410 of the first size, a second feature of a second tile from the second plurality of tiles 420 of the second size, and a third feature of a third tile from the second plurality of tiles 420 of the second size.

At 254, the digital pathology platform 110 may determine a positional embedding for each concatenated feature set including a first feature of a first tile from the first plurality of tiles of the first size, a second feature of a second tile from the second plurality of tiles of the second size, and a third feature of a third tile from the second plurality of tiles of the second size. For example, in some cases, the histological computation model 115 may generate, for each concatenated feature set 306, a corresponding positional embedding 308. In some instances, the positional embedding 308 of the concatenated feature set 306 may include, for example, the first position of the first tile, the second position of the second tile, and/or the third position of the third tile. Moreover, in some cases, the first position of the first tile, the second position of the second tile, and the third position of the third tile may each include a set of coordinates of one or more pixels included in the corresponding tile. For instance, in some cases, the positional embedding 308 of the concatenated feature set 306 may be generated based on the pixel occupying a corner (e.g., top left corner) of one or more of the first tile from the first plurality of tiles 410 of the first size, the second tile from the second plurality of tiles 420 of the second size, and the third tile from the second plurality of tiles 420 of the second size.

At 256, the digital pathology platform 110 may determine, based at least on the attention weighted positional embeddings of the concatenated feature sets, a first bag-level label for the image of the biological sample. Referring again to FIG. 3, in some example embodiments, the histological computation model 115 may include an attention generator network 310 configured to determine, for the positional embedding 308 of each concatenated feature set 306, an attention weight indicative of the relative importance of an individual instance that includes the corresponding tiles and the features contained therein. In this context, the attention weight assigned to the position embedding 308 of the concatenated feature set 306 may be a value corresponding to how much that particular instance contributes to the bag-level label for the image 125. Accordingly, important instances (or key instances) that trigger (or contribute to) the bag-level label may be associated with a higher attention weight than less important instances that have less bearing on the bag-level label. In the example shown in FIG. 3, for instance, the attention generator network 310 may determine, for each of the N positional embeddings 308, a corresponding attention weight a₁, a₂, . . . , a_{N}.

Referring again to FIG. 3, the histological computation model 110 may include an attention-based tile selection and pooling network 312 followed by an instance regressor 314 trained to determine, based at least on the attention weighted instances (e.g., attention weighted position embeddings 308 of the concatenated feature sets 306), a first bag-level label indicating whether the biological sample depicted in the image 125 is associated with a molecular feature such as a gene expression, a gene signature expression, a protein expression, a genetic mutation, a copy number alteration (CNA), cellular phenotype, and/or the like. For example, in some cases, the first bag-level label may be a binary label having a first value (e.g., “1”) to indicate that the biological sample is associated with (or is positive for) the molecular feature or a second value (e.g., “0”) to indicate that the biological sample is not associated with (or is negative for) the molecular feature. In some cases, the instance regressor 314 may be implemented using a neural network, a Hopfield network, and/or the like.

At 258, the digital pathology platform 110 may identify, based at least on a position of each of the first plurality of tiles and the second plurality of tiles, one or more tile clusters. In some example embodiments, the histological computation model 115 may apply a clustering algorithm 316 to identify, within the first plurality of tiles 410 and/or the second plurality of tiles 420, one or more clusters of similar tiles. In some cases, the histological computation model 115 may apply the clustering algorithm 316 to perform a position-based clustering such that the resulting clusters of tiles include spatially proximate tiles (e.g., tiles occupying a same or similar region of the image 125). In the example shown in FIG. 3, the histological computation model 115 may apply the clustering algorithm 316 to determine, within the first plurality of tiles 410 of the first size and the second plurality of tiles 420 of the second size, a k-quantity of tile clusters denoted as C₁, C₂, . . . , Cₖ.

At 260, the digital pathology platform 110 may determine, for each tile cluster, a set of cross-cluster attention weights including a first average attention weight of the tiles in the tile cluster and a second average attention weight of the tiles in the other tile clusters. Referring again to FIG. 3, the histological computation model 115 may perform a cross-cluster attention map (CAM) distillation in order to determine, for each tile cluster, a set of cross-cluster attention weights including, for example, a first average attention weight Cₖa of the tiles that are within the tile cluster k and a second average attention weight nCₖa of the tiles that are not in the tile cluster k but in other tile clusters. In the example shown in FIG. 3, the histological computation model 115 may determine the set of cross-cluster attention weights by performing cross-cluster attention 320 across the tile clusters. To further illustrate, FIG. 4B depicts a schematic diagram illustrating an example of the cross-cluster attention 320 in which the histological computation model 115 determines, based at least on a cross-cluster attention map 450, the first average attention weight Cₖa of the tiles that are within the tile cluster k and a second average attention weight nCₖa of the tiles that are not in the tile cluster k. As shown in FIG. 3, the first average attention weight Cₖa may be associated with a first joint representation of the features of the tiles that are in the tile cluster k while the second average attention weight nCₖa may be associated with a second joint representation of the features of the tiles that are not in the tile cluster k.

At 262, the digital pathology platform 110 may determine, based at least on the cross-cluster attention weights of each tile cluster, a second bag-level label indicating whether the biological sample depicted in the image is associated with the molecular feature. In some example embodiments, the example of the histological computation model 115 shown in FIG. 3 may include an attention-based cluster selection and pooling network 322 and a bag regressor 324 trained to determine, based at least on the attention weighted tile clusters, a second bag-level label indicating whether the biological sample depicted in the image 125 is associated with the molecular feature. For example, as shown in FIG. 3, the second bag-level label may be determined based on, for each tile cluster k, the first joint representation of the features present in the tiles within the tile cluster k weighted by the first average attention weight Cₖa and the second joint representation of the features present in tiles outside of the tile cluster k weighted by the second average attention weight first average attention weight nCₖa. In some cases, the bag regressor 324 may be implemented using a neural network, a Hopfield network, and/or the like.

At 264, the digital pathology platform 110 may determine, based at least on the first bag-level label and the second bag-level label, an overall label indicating whether the biological sample depicted in the image is associated with the molecular feature. For example, as shown in FIG. 3, the histological computation model 115 may determine, based at least on the first bag-level label for the image 125 determined by the instance regressor 314 and the second bag-level label for the image 125 determined by the bag regressor 324, an overall label indicating whether the biological sample depicted in the image 125 is associated with a molecular feature such as a gene expression, a gene signature expression, a protein expression, a genetic mutation, a copy number alteration (CNA), cellular phenotype, and/or the like.

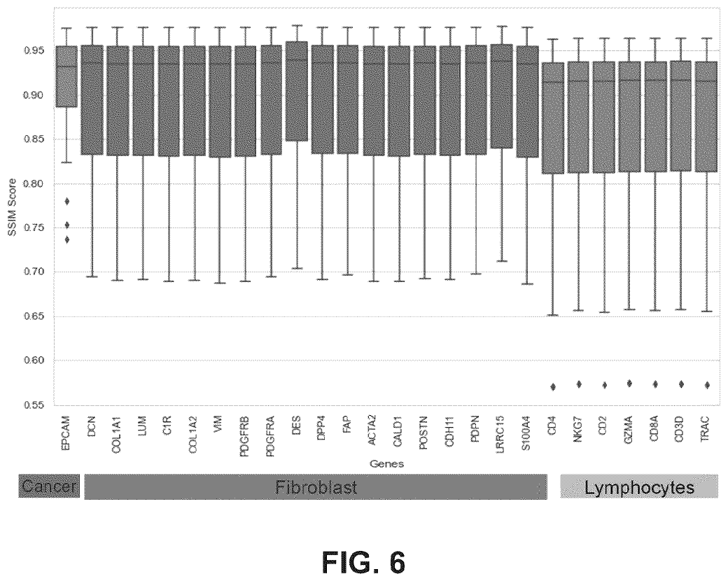

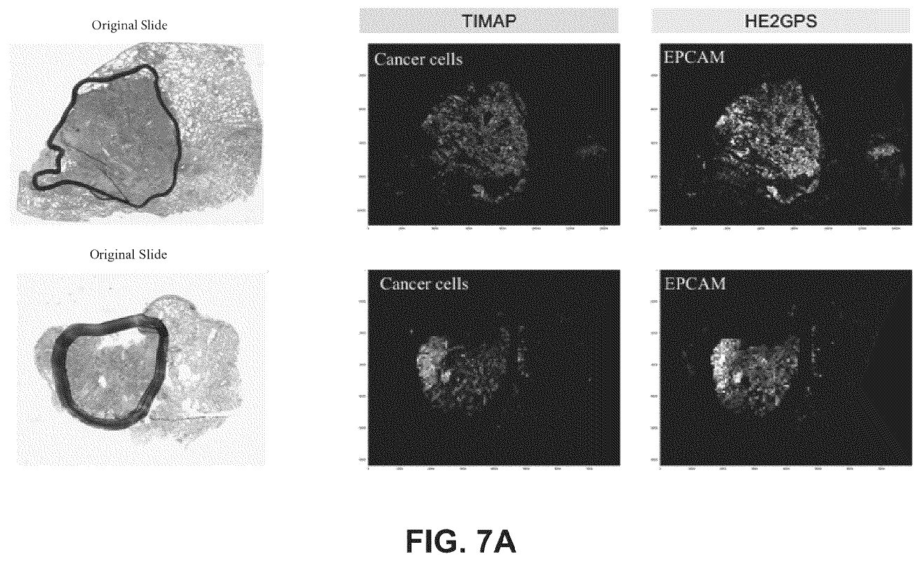

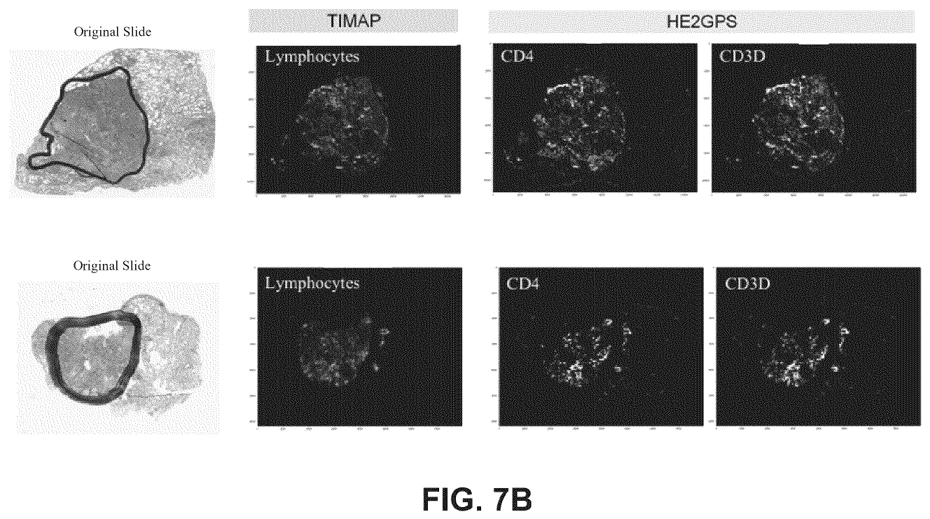

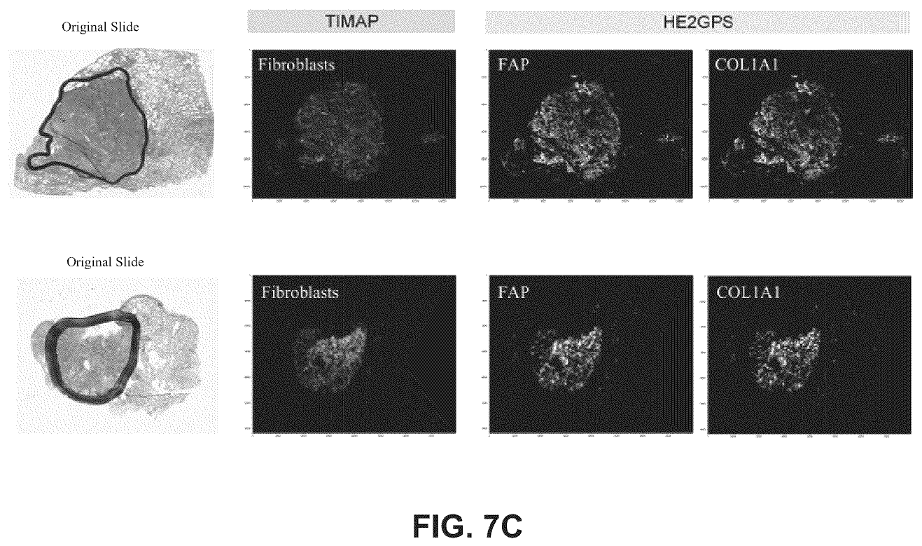

In some example embodiments, the performance of the histological computation model 115 in determining whether the biological sample depicted in the image 125 is associated with a molecular biomarker (e.g., a gene expression, a gene signature expression, a protein expression, a genetic mutation, a copy number alteration (CNA), cellular phenotype, and/or the like) may be evaluated based on concordance between, for example, transforming growth factor (TGF)-β inhibited membrane associated protein (TIMAP) cell masks and tile-level gene expression predictions made by the histological computation model 115. FIG. 6 depicts a graph illustrating a structural similarity (SSIM) index as a measure of concordance between TIMAP cell type predictions and tile-level gene expression predictions made by a histological computation model, in accordance with some example embodiments. FIG. 7A depicts histological images illustrating the concordance between tumor cells identified through TIMAP cell type prediction and tile-level gene expression predictions made by the histological computation model 115. FIG. 7B depicts histological images illustrating the concordance between lymphocytes identified through TIMAP cell type prediction and tile-level gene expression predictions made by the histological computation model 115. FIG. 7C depicts histological images illustrating the concordance between fibroblasts identified through TIMAP cell type prediction and tile-level gene expression predictions made by the histological computation model 115.

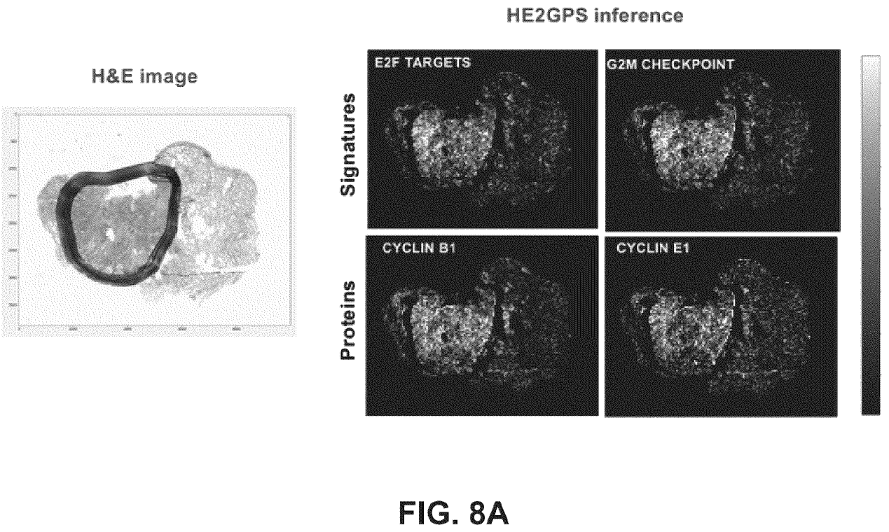

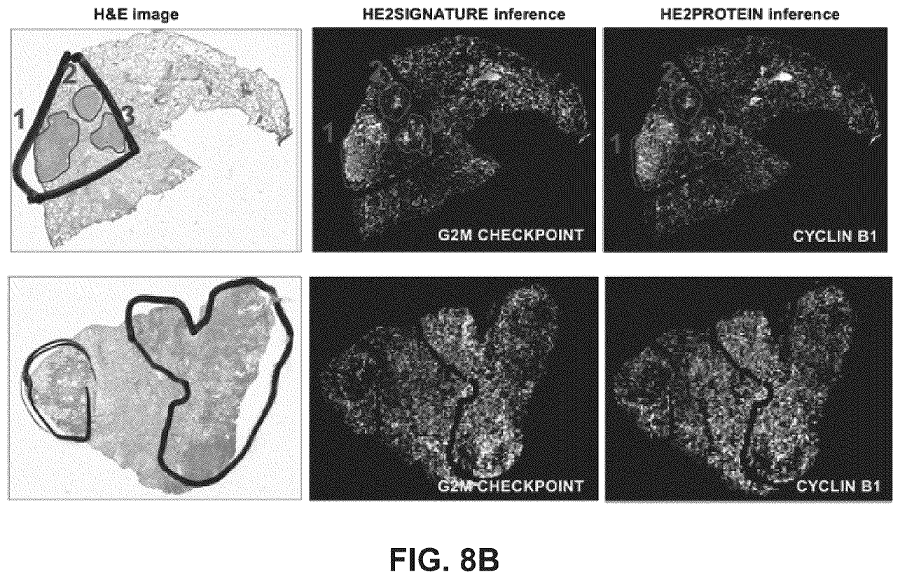

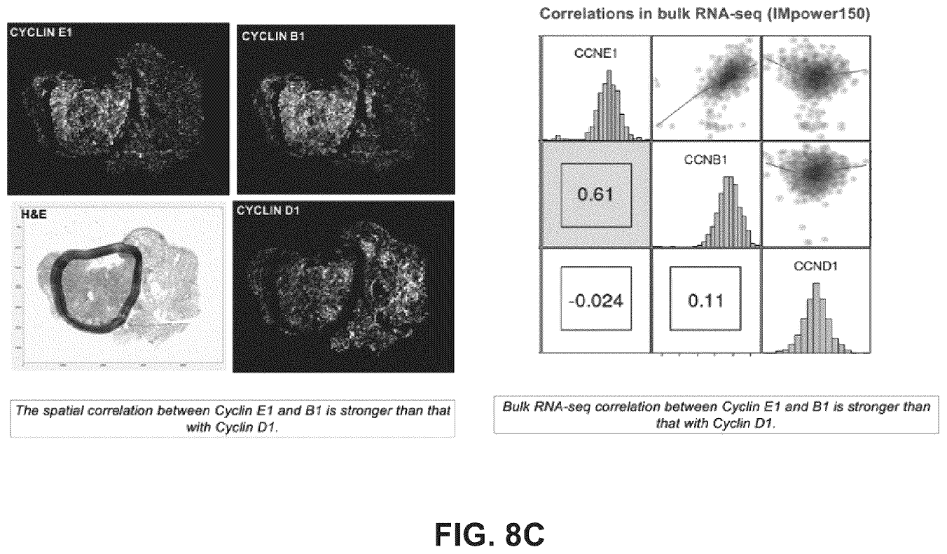

In some cases, the performance of the histological computation model 115 may also be evaluated based on concordance with expert annotations. For example, FIG. 8A depicts histological images of tumor regions localized based on molecular features identified by the histological computation model 115 and the corresponding expert annotations of the same images. FIG. 8B depicts histological images of intratumor heterogeneity captured based on molecular features identified by the histological computation model 115 and the corresponding expert annotations of the same images. In some cases, the predictions made by the histological computation model 115 may also be verified based on the underlying bulk RNA-sequence expression patterns. For instance, FIG. 8C depicts the concordance between the cyclin spatial patterns identified by the histological computation model 115 and the same cyclin patterns identified through bulk RNA-sequence expression.

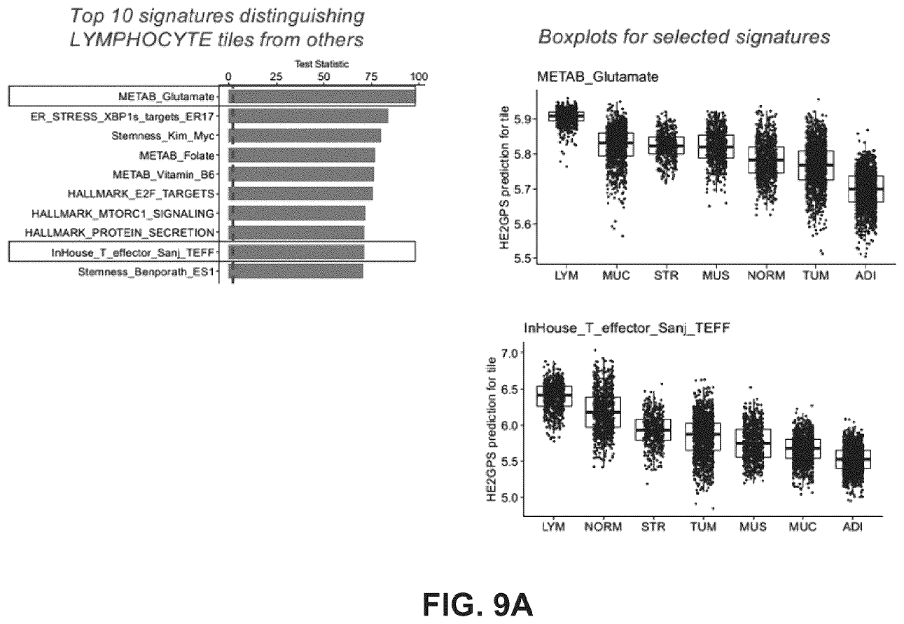

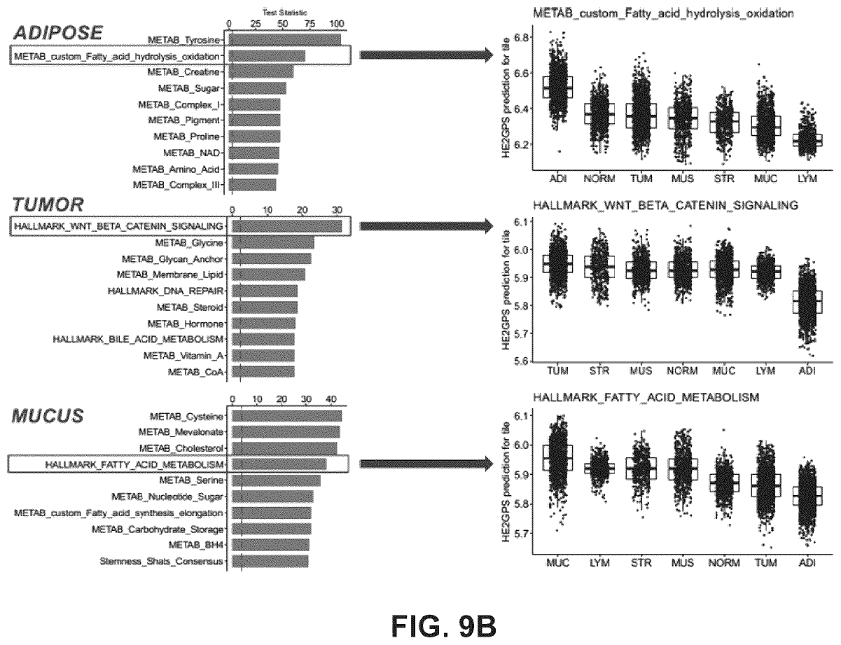

As noted, in some example embodiments, the digital pathology platform 110 may apply the histological computation model 115 to determine whether the biological sample depicted in the image 125 is associated with one or more molecular features including, for example, gene expressions, gene signature expressions, protein expressions, genetic mutations, copy number alterations (CNAs), cellular phenotypes, and/or the like. For example, in some cases, the histological computation model 115 may output, for a particular molecular feature, a binary label having either a first value (e.g., “1”) to indicate that the biological sample is associated with (or is positive for) the molecular feature or a second value (e.g., “0”) to indicate that the biological sample is not associated with (or is negative for) the molecular feature. FIG. 9A depicts various examples of signatures associated with tiles depicting lymphocytes in a histological image such as the image 125 while FIG. 9B depicts various examples of signatures associated with tiles depicting adipose, tumor, and mucus tissue structures in a histological image such as the image 125.

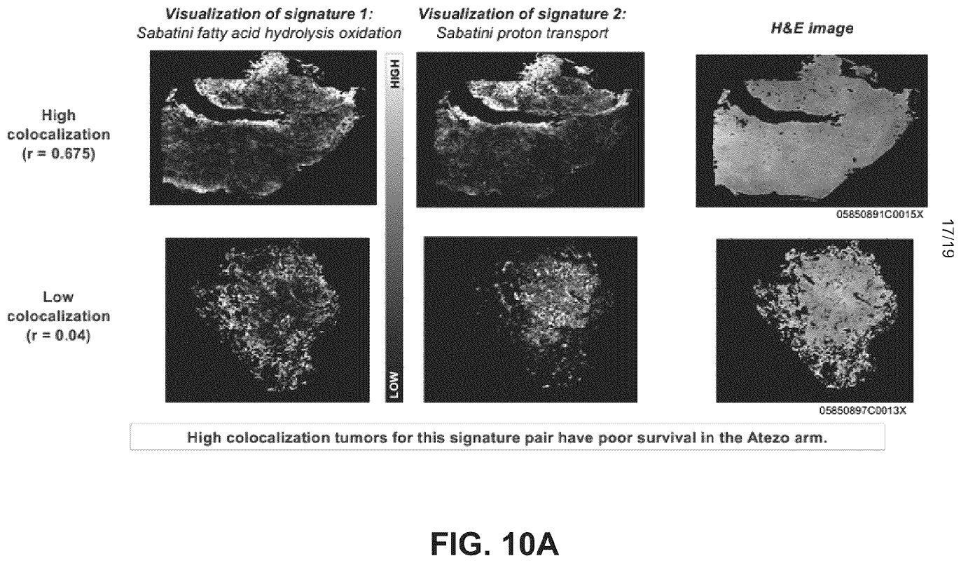

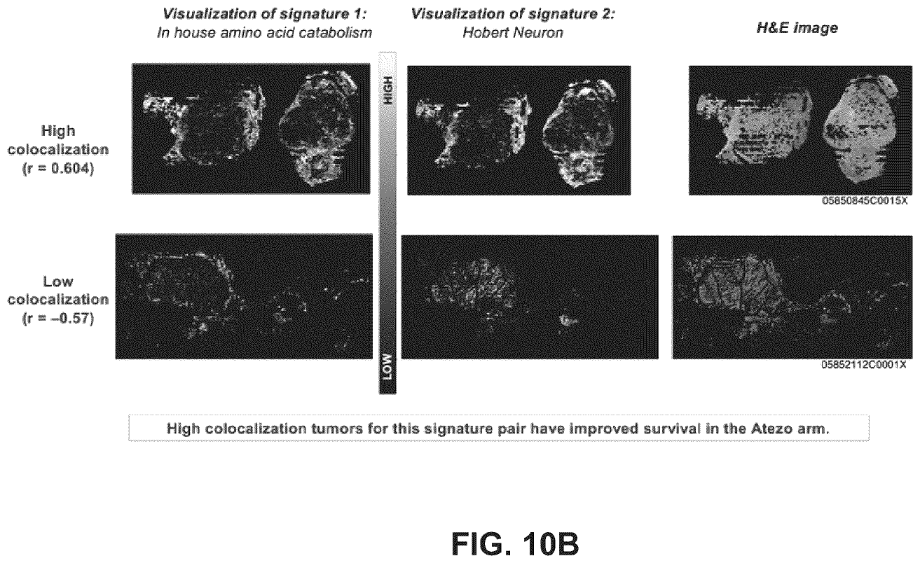

In some example embodiments, the digital pathology platform 110 may perform, based at least on the one or more molecular features, a variety of downstream analytical tasks. For example, in some cases, the one or more molecular features identified within the biological sample depicted in the image 125 may serve as biomarkers for determining at least one of a disease diagnosis, a disease progress, a disease burden, a treatment, a treatment response, and survival prediction for a patient associated with the biological sample. For example, FIG. 10A depicts histological images illustrating fatty acid oxidation and proton transport signature colocalization being a predictive biomarker for prediction of clinical outcomes, in accordance with some example embodiments. FIG. 10B depicts histological images illustrating amino acid catabolism and neuron signature colocalization being a predictive biomarker for prediction of clinical outcomes, in accordance with some example embodiments.

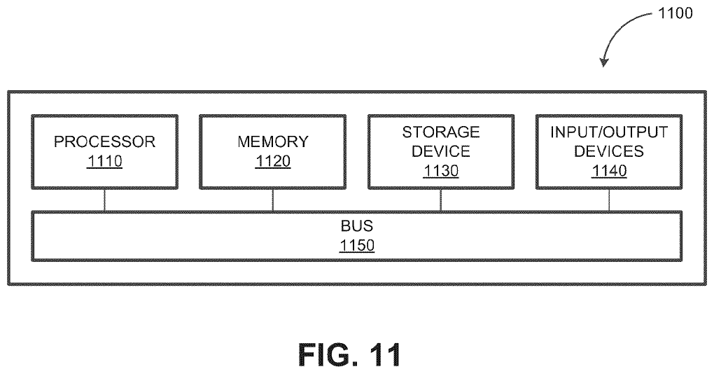

FIG. 11 depicts a block diagram illustrating an example of computing system 1100, in accordance with some example embodiments. Referring to FIGS. 1 and 11, the computing system 1100 may be used to implement the digital pathology platform 110, the imaging system 120, the client device 130, and/or any components therein.

As shown in FIG. 11, the computing system 1100 can include a processor 1110, a memory 1120, a storage device 1130, and an input/output device 1140. The processor 1110, the memory 1120, the storage device 1130, and the input/output device 1140 can be interconnected via a system bus 1150. The processor 1110 is capable of processing instructions for execution within the computing system 1100. Such executed instructions can implement one or more components of, for example, the digital pathology platform 110, the imaging system 120, the client device 130, and/or the like. In some example embodiments, the processor 1110 can be a single-threaded processor. Alternately, the processor 1110 can be a multi-threaded processor. The processor 1110 is capable of processing instructions stored in the memory 1120 and/or on the storage device 1130 to display graphical information for a user interface provided via the input/output device 1140.

The memory 1120 is a computer readable medium such as volatile or non-volatile that stores information within the computing system 1100. The memory 1120 can store data structures representing configuration object databases, for example. The storage device 1130 is capable of providing persistent storage for the computing system 1100. The storage device 1130 can be a floppy disk device, a hard disk device, an optical disk device, or a tape device, or other suitable persistent storage means. The input/output device 1140 provides input/output operations for the computing system 1100. In some example embodiments, the input/output device 1140 includes a keyboard and/or pointing device. In various implementations, the input/output device 1140 includes a display unit for displaying graphical user interfaces.

According to some example embodiments, the input/output device 1140 can provide input/output operations for a network device. For example, the input/output device 1140 can include Ethernet ports or other networking ports to communicate with one or more wired and/or wireless networks (e.g., a local area network (LAN), a wide area network (WAN), the Internet).

In some example embodiments, the computing system 1100 can be used to execute various interactive computer software applications that can be used for organization, analysis and/or storage of data in various formats. Alternatively, the computing system 1100 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 1140. The user interface can be generated and presented to a user by the computing system 1100 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

### Embodiments

Among the provided embodiments are:

1. A computer-implemented method, comprising:
determining, within an image of a biological sample, a first plurality of tiles having a first tile size;
determining, within the image of the biological sample, a second plurality of tiles having a second tile size;
applying a feature extraction model to extract a first plurality of features from the first plurality of tiles of the first size;
applying the feature extraction model to extract a second plurality of features from the second plurality of tiles of the second size; and
determining, based at least on the first plurality of features and the second plurality of features, one or more molecular features present in the biological sample depicted in the image.

2. The method of Embodiment 1, wherein the feature extraction model includes a first machine learning model trained to extract the first plurality of features from the first plurality of tiles having the first tile size, and wherein the feature extraction model further includes a second machine learning model trained to extract the second plurality of features from the second plurality of tiles having the second tile size.

3. The method of any one of Embodiments 1-2, wherein the first tile size of the first plurality of tiles comprises a different quantity of pixels than the second tile size of the second plurality of tiles.

4. The method of any one of Embodiments 1-3, wherein the first plurality of features extracted from the first plurality of tiles having the first tile size comprise global features present in the image of the biological sample, and wherein the second plurality of features extracted from the second plurality of tiles having the second tile size comprise local features present in the image of the biological sample.

5. The method of any one of Embodiments 1-4, wherein the first plurality of features extracted from the first plurality of tiles having the first tile size comprise cellular-scale features, and wherein the second plurality of features extracted from the second plurality of tiles having the second tile size comprise millimeter-scale features.

6. The method of any one of Embodiments 1-5, wherein the first tile size of the first plurality of tiles is 56 pixels by 56 pixels.

7. The method of any one of Embodiments 1-6, wherein the second tile size of the second plurality of tiles is 224 pixels by 224 pixels.

8. The method of any one of Embodiments 1-7, further comprising:
determining, within the image of the biological sample, a third plurality of tiles having a third size;
applying the feature extraction model to extract a third plurality of features from the third plurality of tiles; and
determining, based at least on the third plurality of features, the one or more molecular features in the biological sample.

9. The method of any one of Embodiments 1-8, further comprising:
concatenating the first plurality of features and the second plurality of features; and
determining, based at least on a concatenation of the first plurality of features and the second plurality of features, the one or more molecular features present in the biological sample.

10. The method of Embodiment 9, wherein the concatenating of the first plurality of features and the second plurality of features includes concatenating a first feature associated with a first tile of the first plurality of tiles of the first size with a second feature associated with a second tile of the second plurality of tiles of the second size.

11. The method of Embodiment 10, wherein the concatenating of the first plurality of features and the second plurality of features further includes concatenating a second feature associated with the first tile of the first plurality of tiles of the first size with the second feature associated with the second tile of the second plurality of tiles of the second size.

12. The method of Embodiment 10, wherein the concatenating of the first plurality of features and the second plurality of features further includes concatenating the first feature of the first tile and the second feature of the second tile with a third feature of a third tile of the second plurality of tiles of the second size.

13. The method of Embodiment 12, further comprising:
generating a positional embedding of a concatenated feature set including the first feature of the first tile, the second feature of the second tile, and the third feature of the third tile.

14. The method of Embodiment 13, wherein the positional embedding includes a first position of the first tile, a second position of the second tile, and/or a third position of the third tile.

15. The method of Embodiment 14, where in the first position of the first tile, the second position of the second tile, and the third position of the third tile each includes a set of coordinates of at least one pixel from the corresponding tile.

16. The method of any one of Embodiments 1-15, further comprising:
determining, based at least on a positional embedding of a concatenated feature set associated with each tile of the first plurality of tiles and two or more corresponding tiles of the second plurality of tiles, a first bag-level label indicative of the one or more molecular features present in the biological sample.

17. The method of Embodiment 16, wherein the one or more molecular features are further determined based at least on an attention weight associated with each positional embedding.

18. The method of Embodiment 17, wherein the one or more molecular features are determined by applying an attention-based tile selection and pooling network and an instance regressor to a plurality of attention-weighted positional embeddings.

19. The method of Embodiment 16, further comprising:
determining, based at least a joint representation of features associated with one or more clusters of tiles, a second bag-level label indicative of the one or more molecular features present in the biological sample.

20. The method of Embodiment 19, further comprising:
clustering, into the one or more clusters of tiles, the first plurality of tiles and the second plurality of tiles.

21. The method of Embodiment 20, wherein the clustering is performed based at least on a positional information of each tile of the first plurality of tiles and the second plurality of tiles.

22. The method of Embodiment 20, wherein the first plurality of tiles and the second plurality of tiles are clustered into a configurable quantity of clusters.

23. The method of Embodiment 20, further comprising:
determining, for each cluster of tiles, a first average attention weight for features of tiles in the cluster and a second average attention weight for features of tiles not in the cluster.

24. The method of Embodiment 23, further comprising:
determining, based at least on the first average attention weight applied to a first joint representation of the features of the tiles in the cluster and the second average attention weight applied to a second joint representation of the features of the tiles not in the cluster, the one or more molecular features present in the biological sample.

25. The method of Embodiment 24, wherein the one or more molecular features present in the biological sample are determined by at least applying an attention-based cluster selection and pooling network and a bag-level regressor to the first average attention weight applied to the first joint representation of the features of the tiles in the cluster and the second average attention weight applied to the second joint representation of the features of the tiles not in the cluster.

26. The method of Embodiment 19, further comprising:
determining, based at least on the first bag-level label and the second bag-level label, an overall label indicative of the one or more molecular features present in the biological sample.

27. The method of any one of Embodiments 1-26, wherein the feature extraction model is a vision transformer.

28. The method of any one of Embodiments 1-27, wherein the image is a whole slide image.

29. The method of any one of Embodiments 1-28, wherein the image is a hematoxylin and eosin (H&E) stained whole slide image.

30. The method of any one of Embodiments 1-29, wherein the biological sample includes one or more tissue fragments, free cells, and/or body fluids.

31. The method of any one of Embodiments 1-30, wherein the biological sample includes tumor tissue.

32. The method of any one of Embodiments 1-31, wherein the feature extraction model is trained to extract features associated with a specific disease or a specific subtype of disease.

33. The method of any one of Embodiments 1-32, wherein the feature extraction model is trained to extract features associated with a specific cancer or a specific subtype of cancer.

34. The method of any one of Embodiments 1-33, wherein the one or more molecular features include a gene expression, a gene signature expression, a protein expression, a genetic mutation, a copy number alternation (CNA), and/or a cellular phenotype.

35. The method of any one of Embodiments 1-34, further comprising:
identifying, based at least on the one or more molecular features present in the biological sample, one or more biomarkers and disease-modifying target genes.

36. The method of any one of Embodiments 1-35, further comprising:
performing, based at least on the one or more molecular features present in the biological sample, bulk RNA sequence prediction.

37. The method of any one of Embodiments 1-36, further comprising:
performing, based at least on the one or more molecular features present in the biological sample, in silico spatial transcriptomics to determine a spatial distribution of genetic activities occurring within the biological sample.

38. The method of any one of Embodiments 1-37, further comprising:
determining, based at least on the one or more molecular features present in the biological sample, at least one of a disease diagnosis, a disease progress, a disease burden, a treatment, a treatment response, and survival prediction for a patient associated with the biological sample.

39. A system, comprising:
at least one data processor; and
at least one memory storing instructions, which when executed by the at least one data processor, result in operations comprising the method of any of Embodiments 1 to 38.

40. A non-transitory computer readable medium storing instructions, which when executed by at least one data processor, result in operations comprising the method of any of Embodiments 1 to 38.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method, comprising:
determining, within an image of a biological sample, a first plurality of tiles having a first tile size;
determining, within the image of the biological sample, a second plurality of tiles having a second tile size;
applying a feature extraction model to extract a first plurality of features from the first plurality of tiles of the first size;
applying the feature extraction model to extract a second plurality of features from the second plurality of tiles of the second size; and
determining, based at least on the first plurality of features and the second plurality of features, one or more molecular features present in the biological sample depicted in the image.

2. The method of claim 1, wherein the feature extraction model includes a first machine learning model trained to extract the first plurality of features from the first plurality of tiles having the first tile size, and wherein the feature extraction model further includes a second machine learning model trained to extract the second plurality of features from the second plurality of tiles having the second tile size.

3. The method of claim 1, wherein the first tile size of the first plurality of tiles comprises a different quantity of pixels than the second tile size of the second plurality of tiles.

4. The method of claim 1, wherein the first plurality of features extracted from the first plurality of tiles having the first tile size comprise global features present in the image of the biological sample, and wherein the second plurality of features extracted from the second plurality of tiles having the second tile size comprise local features present in the image of the biological sample.

5. The method of claim 1, wherein the first plurality of features extracted from the first plurality of tiles having the first tile size comprise cellular-scale features, and wherein the second plurality of features extracted from the second plurality of tiles having the second tile size comprise millimeter-scale features.

6. The method of claim 1, wherein the first tile size of the first plurality of tiles is 56 pixels by 56 pixels.

7. The method of claim 1, wherein the second tile size of the second plurality of tiles is 224 pixels by 224 pixels.

8. The method of claim 1, further comprising:
determining, within the image of the biological sample, a third plurality of tiles having a third size;
applying the feature extraction model to extract a third plurality of features from the third plurality of tiles; and
determining, based at least on the third plurality of features, the one or more molecular features in the biological sample.

9. The method of claim 1, further comprising:
concatenating the first plurality of features and the second plurality of features; and
determining, based at least on a concatenation of the first plurality of features and the second plurality of features, the one or more molecular features present in the biological sample.

10. The method of claim 1, further comprising:
determining, based at least on a positional embedding of a concatenated feature set associated with each tile of the first plurality of tiles and two or more corresponding tiles of the second plurality of tiles, a first bag-level label indicative of the one or more molecular features present in the biological sample.

11. The method of claim 1, wherein the image is a hematoxylin and eosin (H&E) stained whole slide image.

12. The method of claim 1, wherein the biological sample includes one or more tissue fragments, free cells, and/or body fluids.

13. The method of claim 1, wherein the feature extraction model is trained to extract features associated with a specific disease or a specific subtype of disease.

14. The method of claim 1, wherein the one or more molecular features include a gene expression, a gene signature expression, a protein expression, a genetic mutation, a copy number alternation (CNA), and/or a cellular phenotype.

15. The method of claim 1, further comprising:
identifying, based at least on the one or more molecular features present in the biological sample, one or more biomarkers and disease-modifying target genes.

16. The method of claim 1, further comprising:
performing, based at least on the one or more molecular features present in the biological sample, bulk RNA sequence prediction.

17. The method of claim 1, further comprising:
performing, based at least on the one or more molecular features present in the biological sample, in silico spatial transcriptomics to determine a spatial distribution of genetic activities occurring within the biological sample.

18. The method of claim 1, further comprising:
determining, based at least on the one or more molecular features present in the biological sample, at least one of a disease diagnosis, a disease progress, a disease burden, a treatment, a treatment response, and survival prediction for a patient associated with the biological sample.

19. A system, comprising:
at least one data processor; and
at least one memory storing instructions, which when executed by the at least one data processor, result in operations comprising:
determining, within an image of a biological sample, a first plurality of tiles having a first tile size;
determining, within the image of the biological sample, a second plurality of tiles having a second tile size;
applying a feature extraction model to extract a first plurality of features from the first plurality of tiles of the first size;
applying the feature extraction model to extract a second plurality of features from the second plurality of tiles of the second size; and
determining, based at least on the first plurality of features and the second plurality of features, one or more molecular features present in the biological sample depicted in the image.

20. A non-transitory computer readable medium storing instructions, which when executed by at least one data processor, result in operations comprising:
determining, within an image of a biological sample, a first plurality of tiles having a first tile size;
determining, within the image of the biological sample, a second plurality of tiles having a second tile size;
applying a feature extraction model to extract a first plurality of features from the first plurality of tiles of the first size;
applying the feature extraction model to extract a second plurality of features from the second plurality of tiles of the second size; and
determining, based at least on the first plurality of features and the second plurality of features, one or more molecular features present in the biological sample depicted in the image.
